(19) United States
(12) Patent Application Publication
(10) Pub. No.: US 2025/0127325 A1
(43) Pub. Date: Apr. 24, 2025

(54) LOCKABLE BREWING UNIT

(71) Applicant: EUGSTER / FRISMAG AG, Amriswil (CH)

(72) Inventors: Patrick Egger, Niederbüren (CH); Wolfgang Riessbeck, Landschlacht (CH); Roman Scheurer, Felben-Wellhausen (CH)

(73) Assignee: EUGSTER / FRISMAG AG, Amriswil (CH)

(21) Appl. No.: 18/689,958

(22) PCT Filed: Jun. 28, 2022
(86) PCT No.: PCT/EP2022/067763

§ 371 Date: Mar. 7, 2024

(30) Foreign Application Priority Data
Sep. 10, 2021 (DE) 10 2021 123 554.5

(51) Int. Cl. A47J 31/44; A47J 31/36

(52) U.S. Cl. CPC A47J 31/4403; A47J 31/3623

(57) ABSTRACT

The invention relates to a brewing unit (01) for a beverage preparation apparatus for substrate portions, in particular for a coffee machine for pre-portioned coffee units, having a support (09) and a brewing chamber which has at least two brewing chamber halves (02, 32), which are movable relative to one another in a first direction (08), and has a drive device (28), by means of which at least one brewing chamber half (02) can be moved relative to the support (09) such that the brewing chamber halves (02, 32) can be transferred at least into an open position and a closed position, and a separate locking mechanism for locking the brewing chamber halves (02, 32) in a closed position. According to the invention, the locking mechanism comprises four locking elements (03).

### BACKGROUND OF THE INVENTION

The invention relates to a brewing unit for a beverage preparation device for substrate portions, in particular a coffee machine for pre-portioned coffee units.

Various beverage preparation devices and related brewing units are known from the prior art, which serve to process a substrate portion or a pre-portioned coffee unit, for example in capsule form, and to extract, in particular brew, a beverage from the substrate of the substrate portion as part of the processing, a brewing fluid, for example hot water, regularly being brought into contact with the substrate and/or the substrate portion while under pressure. The action or bringing into contact between the substrate and the brewing fluid generally takes place in a brewing chamber which is sufficiently sealed to absorb the desired or necessary excess pressure of the brewing fluid during the brewing process and thus the prevailing internal pressure in the brewing chamber, without brewing fluid and/or brewed beverage escaping from the brewing chamber at points which do not correspond to the desired and intended beverage outlet.

Various approaches are known in the state of the art to absorb or overcompensate for the pressures or excess pressures prevailing inside the brewing chamber during the brewing process. Firstly, brewing units having two brewing-chamber halves or brewing-chamber parts which can be moved relative to one another are known, one, preferably movable, brewing-chamber half being moved using a toggle lever mechanism, in particular towards the second brewing-chamber half, and the toggle lever mechanism applying force to the brewing-chamber halves towards one another in as stretched or straight a state as possible or presses them against one another in such a manner that a sufficient sealing effect is achieved on contact surfaces of the brewing-chamber halves, possibly supported by corresponding sealing devices.

As a further development to a mechanical clamping or tensioning of the brewing-chamber halves only via a drive apparatus, such as the toggle mechanism, it is also already known in the prior art to provide a separate locking mechanism in addition to a toggle mechanism, the locking mechanism locking the brewing-chamber halves in a locked position. One such approach is known in applicant's DE 10 2012 108 653 A1, for example.

While the locking mechanism provided separately from a drive apparatus makes it possible in principle to relieve or reduce the stress on the drive apparatus during the brewing process, in particular while high internal pressures are present inside the brewing chamber in the locked position, a disadvantage of the known approach is, however, that the known locking mechanisms require a relatively large installation space, since they provide locking elements of the locking mechanism centrally or at half the height of a brewing unit in which the brewing-chamber halves have a maximum width, the additional locking elements to be provided next to or outside the brewing-chamber halves at this point or at this height further increasing or enlarging the required width or the necessary width of the brewing unit. Furthermore, the known use of a separate locking mechanism having central locking elements at approximately half the height of the brewing-chamber half is disadvantageous because this can cause or result in rotational and tilting moments in the upper and lower areas of the brewing-chamber halves due to the internal pressure within the brewing chamber in the locked position, which can only be poorly absorbed by the centrally disposed or half-height locking elements and can lead to leakage of the brewing chamber during the brewing process, particularly in the long term and thus with the onset of wear of components.

EP 3 493 713 B1 discloses a brewing unit for coffee capsules having a latching mechanism for latching or securing a movable brewing-chamber half in a brewing position. The latching mechanism is annular in shape and thus embraces a projection of the movable brewing-chamber half over the entire circumference.

EP 2 934 243 B1 teaches a self-locking brewing unit for coffee capsules. In this context, it describes two opposite locking elements in a brewing-chamber half on the outlet side, which serve to adapt a brewing-chamber size to different capsule sizes. The locking elements thus do not serve to secure the locked position of the brewing-chamber halves in the brewing position. The disclosure further intends that several locking elements, for example 3, 4, 6 or 8 locking elements, can also be used in order to adapt the brewing chamber size accordingly.

DE 603 03 320 T2 also discloses a brewing unit for coffee capsules, which has two opposite locking elements for locking the brewing-chamber half in a closed state.

WO 2014/029685 discloses a brewing unit for extracting a portion capsule having a first brewing-chamber half and a second brewing-chamber half which are held in the closed state via a locking device separate from a toggle joint.

### SUMMARY OF THE INVENTION

With this background, the object of the present invention is to propose a brewing unit which overcomes the disadvantages of the prior art and, in particular, enables locking the brewing-chamber halves in the closed position in a space-saving and/or compact manner and at the same time in a permanently secure and reliable manner.

The object mentioned above is attained by a brewing unit having the features disclosed herein.

Advantageous embodiments of the brewing unit are the subject matter of the following description, description of the figures, the figures and the dependent claims.

The brewing unit for a beverage preparation device for substrate portions, in particular for a coffee machine for pre-portioned coffee units, comprises in a generally known manner a carrier and a brewing chamber, which has at least two brewing-chamber halves movable in relation to each other in a first direction. In its generic design, the brewing unit further comprises a drive apparatus, by means of which at least one brewing-chamber half is movable in relation to the carrier and/or to at least the second brewing-chamber half so the brewing-chamber halves are transferable to at least an open position and a locked position. Furthermore, the brewing unit comprises in a known manner a separate locking mechanism for locking the brewing-chamber halves in a locked position.

According to the invention, it is further provided that the locking mechanism comprises four locking elements.

The realization of four locking elements generally ensures that the locking elements do not define a locking axis or a locking line, for example at about half the height of the brewing-chamber halves in the width direction and thus perpendicular to the first direction, but instead ensures that the total of four locking elements inevitably span a locking plane, which in turn means that rotational and tilting moments, which can be generated in particular in the edge areas of the brewing-chamber halves by the excess pressure inside the brewing chamber, can be absorbed and dissipated better than with locking elements which only form a locking line or locking axis, for example at about half the height and half the height direction.

Furthermore, when realizing four locking elements as intended by the invention, an eccentric arrangement of the locking elements is inevitably or at least almost inevitably realized, so that the locking elements are then disposed in areas where the brewing-chamber halves do not have their maximum height or width extension, so that the locking elements do not fundamentally increase the installation space or the volume of the brewing unit, but at least some installation space can be used, which must be available at any rate due to the expansions of the brewing-chamber halves, for example in the area of their maximum height and width.

The basic idea of the present invention is thus based on the realization that an eccentrically disposed plurality of locking elements, namely four locking elements, which are preferably (horizontally or vertically) disposed off-center to the symmetry plane, enables a simultaneously space-saving and secure locking of the brewing chamber or brewing-chamber halves in the closed position.

According to a first, particularly advantageous embodiment, it may be intended that the locking elements span a plane perpendicular to the first direction. This means that the locking elements are all disposed at the same height or position in relation to the first direction, either in principle or at least in the closed position of the brewing-chamber halves, and thus span a plane which is perpendicular to the first direction. This achieves in a particularly advantageous manner that the internal pressure of the brewing chamber can be absorbed and dissipated evenly and uniformly by the locking elements especially at the edges of the brewing-chamber halves, while at the same time keeping tilting and rotational moments small or minimal.

Furthermore, it may advantageously be provided that the carrier has latching recesses or latching indentations in which the locking elements engage in a locked position, the latching recesses or latching indentations being formed in horizontal surfaces of the carrier. Particularly preferably, the latching recesses or latching indentations can be formed or molded into lid or base sections of the carrier. This can save space, particularly in the width direction of the brewing unit. In the following, the latching recesses or latching indentations will be referred to simply as latching recesses, without limiting the technical meaning, but only to shorten the name. In principle, however, indentations can be provided which do not completely penetrate the surface or wall in which they are formed, as well as recesses which completely penetrate the surface or wall in which they are disposed.

It should be mentioned here that terms such as top, bottom, side/lateral in relation to the present brewing unit and its components are to be defined essentially on the basis of an insertion opening of the brewing unit for beverage substrates. This insertion opening is aligned upwards or extends through an upper side or surface of the brewing unit. The opposite side or surface of the brewing unit, which then generally but not necessarily has an outlet or ejector for used substrate portions, should be understood as the underside or generally in relation to a direction as “bottom”. The sides, which are spaced apart in the width direction, should then extend between the top side and the underside or the top end and the bottom end of the brewing unit. In contrast, the height direction is defined or specified between the top side and the underside. The first direction in which the brewing-chamber halves are moved in relation to each other is perpendicular to both the width direction and the height direction in order to move the brewing-chamber halves to the closed position and the open position.

According to another advantageous embodiment, it may be intended that the latching recesses are disposed in the edge area of the carrier, preferably abutting to a lateral wall of the carrier, in a width direction perpendicular to the first direction. This forms an almost maximal eccentricity of the four locking elements in relation to the central symmetry surfaces of the brewing-chamber halves, i.e., horizontal and vertical planes parallel to the first direction and extending through the center point or a central symmetry axis of the brewing-chamber halves. The arrangement of the latching recesses at the edges or almost at the edges in the carrier, preferably in the upper and lower lid and base surfaces of the carrier, leads to an overall space saving and also prevents, in a particularly advantageous manner, any resulting tilting and/or rotational moments of the brewing-chamber halves in the closed position of the brewing chamber. The corresponding arrangement of the latching recesses also determines the arrangement of the locking elements, as these should engage therein in the locked position. Due to the arrangement of the latching recesses at the edge, a lateral arrangement and/or an arrangement of the locking elements at the edge is advantageously preferred, which in turn supports the space saving and the improved force reception.

Furthermore, according to an advantageous embodiment of the brewing unit, it can be intended that the locking elements engage in the latching recesses of the brewing chamber or brewing-chamber halves in pairs from the inside towards the top and towards the bottom for attaining the locked position. This makes it possible to achieve a secure and uniform locking of the brewing-chamber half in the locked position. Furthermore, by engaging the locking elements in pairs from the inside towards the top and towards the bottom, an internal arrangement of the locking elements is achieved or even required, which leads to a space-saving design of the brewing unit.

Alternatively, the locking elements can also be rotated by 90°. In this case, the locking elements could engage in the latching recesses in pairs from the inside towards the right and left to reach the closed position of the brewing chamber or brewing-chamber halves. In this case, the latching recesses would preferably be formed in the lateral surfaces adjacent to the lid and base surfaces of the carrier.

Likewise, in an advantageous embodiment of the brewing unit, it can be intended that the locking elements are connected to the movable brewing-chamber halves such that a movement of the brewing-chamber halves causes a corresponding movement of the locking elements, in particular in translational terms, in the first direction.

It can also be particularly advantageous for the locking elements to each be connected to a brewing-chamber half, which is formed so as to be movable with respect to the carrier, in a pivotable manner via kingpins, which extend in the width direction. This allows the locking elements to be rotated or pivoted so that especially the transition between the released position and a locked position of the locking elements is achieved by pivoting or rotating the locking elements about said kingpin. If necessary, the pivoting can advantageously be superimposed in sections or temporarily with a translational movement of the locking elements in the first direction via a connection to the movable brewing-chamber half.

In variant of the brewing unit as intended by the invention, it can be intended that the locking elements are movable, in particular pivotable, in pairs between a locked position and a released position via control valves movable or disposed so as to be movable between pairs of or each disposed between two locking elements. The control valves preferably move or control two locking elements simultaneously and/or in pairs so that in particular only two control valves are required for the total of four locking elements and are included in the brewing unit.

It is particularly preferable, especially in the case of a design and arrangement of the locking elements at the edge, that the control valves are integrated in a housing of the brewing-chamber half, which is mounted or disposed so as to be movable with respect to the carrier. In this case, not only is a space-saving realization achieved, but it is also made possible that the control valves are disposed in a plane and can be moved in a plane which is formed or defined by the two locking elements to be controlled. As a result, a direct and in particular offset-free transfer of control forces from the control valves to the locking elements can be achieved.

Further, it may be intended that the control valves are formed so as to be movable in the first direction with respect to the brewing-chamber halves mounted movable with respect to the carrier and preferably are formed so as to be movable with respect to the carrier itself. This means that, depending on the movement of the brewing unit, in particular the movable brewing-chamber half, the control valves can move or shift with respect to the brewing-chamber half in the first direction, preferably until the control valve abuts against mechanical stops, such as the locking elements. Depending on the movement of the brewing unit, however, the control valves can also only be movable with respect to the carrier, for example if there is forced guidance with the brewing-chamber half, for example caused by stops. Finally, it is also possible for the control valves to move or be able to move, preferably in a corresponding released position or a corresponding released area, both with respect to the carrier and with respect to the brewing-chamber half.

Advantageously, the control valves are designed as control plates, whose surface extends parallel to lateral walls of the carrier. The design as control plates makes it particularly advantageous to control locking elements in pairs and at the same time while taking up little space.

In an embodiment of the invention according to the invention, it is also intended that the control valves are designed as plano-concave control plates, the control valves having an exterior, plane base surface, which is disposed parallel to lateral walls of the carrier, and an opposite, interior, concave base surface, which is disposed so as to be movable with respect to a convex surface of a casing of a brewing-chamber half. The plano-concave design of the control valves allows space to be saved in a particularly advantageous manner, since the control valve or the control plates do not have to be disposed in the width direction next to the movable brewing-chamber half, but can instead be designed to partially overlap with the brewing-chamber half in the width direction.

In a particularly advantageous further development, it can be intended that an inner base surface of the control plate, preferably the concave base surface of the control plate, has a groove along the first direction, the groove being engaged with a guide web on a surface, preferably a convex surface, of a casing of the movable brewing-chamber half. This advantageously supports the guidance of the control valves or control plates along the first direction and at the same time enables movement with respect to the brewing-chamber half.

Furthermore, it can be advantageously intended that the control plate has a guiding spike/locating pin, which is inserted in a spring-loaded reception of the brewing-chamber half when transferring the locking elements to the locked position. This advantageously facilitates and enables the unlocking of the brewing-chamber halves and/or a contact pressure between the brewing-chamber halves introduced or produced dynamically in addition to the locking elements.

In addition, in another, particularly preferred embodiment of the brewing unit, it can be intended that the control valves, in particular control plates, are connected to the drive apparatus via external drive bolts, in particular external in the width direction. The external drive bolts enable the drive apparatus to be disposed partially or completely outside the carrier and to introduce or apply the drive energy laterally from the outside into the brewing unit, in particular onto the movable brewing chamber, only or also via the drive bolts. This leads to additional savings in installation space or construction volume.

In another embodiment, it is also intended that the drive bolts extend through recesses in the carrier on both sides of the brewing unit. Recesses can, for example, be slotted holes or comparable recesses. The recesses allow the drive bolts to pass through in a particularly effective manner and thus an external drive apparatus which transmits the drive energy to the movable brewing-chamber half via the drive bolts and the control valves, in particular control plates.

Accordingly, in an advantageous embodiment, it can be intended that the drive bolts are connected to a drive-shaft extractor of the drive apparatus, in particular to extractor legs movable along lateral walls of the carrier on both sides, the drive-shaft extractor being disposed on the exterior of the carrier. The connection to the extractor legs does not necessarily have to be direct or immediate. Rather, it can be advantageous if the connection to the extractor legs is indirect, preferably via a joint disposed on the extractor legs or a rotation axis connected to the extractor legs. The use of a drive-shaft extractor with two extractor legs disposed on the sides of the brewing unit and movable along lateral walls of the carrier enables, in a particularly advantageous manner, the uniform and synchronous actuation of the control valves, in particular control plates, from the outside on both sides of the carrier.

It can be particularly advantageous that the drive-shaft extractor comprises a rotation axis which connects the extractor legs, is disposed on the carrier so as to be rotational and preferably is pre-stressed in a rotation direction using pre-stressing means. This makes it possible to realize a relatively simple drive apparatus—in relation to a toggle mechanism-which is essentially based on the rotation of the rotation axis, the rotation of the rotation axis being transferred via the extractor legs and then being directly, but particularly preferably indirectly, transferred via the extractor legs into a linear movement of the movable brewing-chamber half, preferably via the drive pins connected to the extractor legs and the control valves or control plates.

Furthermore, the object mentioned in the subject matter is attained by a beverage preparation device for substrate portions, in particular a coffee machine for pre-portioned coffee units having a brewing unit according to one of the embodiments described above.

### BRIEF DESCRIPTION OF THE DRAWINGS

Advantages and advantageous embodiments of the brewing unit according to the invention are explained below with reference to the merely exemplary, schematic drawings.

FIG. 1: shows a perspective view of a brewing-chamber half having locking elements;

FIG. 2: shows a perspective sectional view of parts of a brewing unit in a closed position of the brewing-chamber halves;

FIG. 3: shows a perspective view of parts of a brewing unit according to the invention in a closed position of the brewing-chamber halves;

FIG. 4: shows a sectional side view of a brewing unit according to the invention in a closed position of the brewing-chamber halves;

FIG. 5: a sectional top view of a brewing unit in a closed position of the brewing-chamber halves.

### DETAILED DESCRIPTION

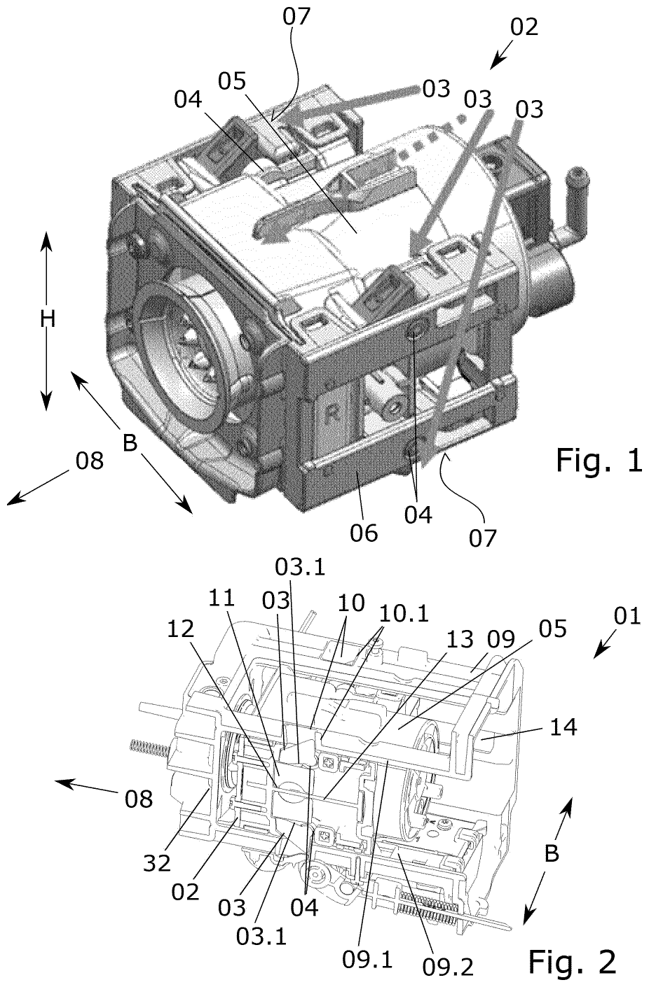

FIG. 1 shows a brewing-chamber half 02, which can be disposed so as to be movable in a carrier of a brewing unit (not shown). The brewing-chamber half 02 comprises four locking elements 03, of which a total of three locking elements 03 can be seen in the perspective view of FIG. 1. The locking elements 03 are disposed on and fastened to the brewing-chamber half 02, the locking elements 03 being connected via kingpins 04 on both sides both to an approximately cylindrical inner casing 05 and to a cage-like outer casing 06 of the brewing-chamber half 02. The locking elements 03 can be rotated around the kingpin 04 into a released position and into a locked position. In the illustration in FIG. 1, the locking elements 03 are in the locked position. The transfer between the released and the locked position of the locking elements 03 is realized via control valves, in particular control plates on both sides of the brewing-chamber half 02, which are not visible in detail in the illustration of FIG. 1. With regard to the control valves, in particular control plates, reference is made to the following illustrations.

However, it can be seen that a reception 06 for a drive bolts is provided laterally in the height direction H between the locking elements 03. The reception 06 can be connected to the control valve or the control plate. Via the reception, a drive bolts (not shown) can be guided laterally through recesses into a carrier (not shown), where it can be connected or linked to elements of a drive apparatus outside the carrier.

As can be seen from the kingpin 04, the locking elements 03 engage in pairs from the inside towards the top and towards the bottom in corresponding latching recesses in the carrier. The locking elements 03 are each disposed on the side or edge of an upper or lower side of the brewing-chamber half 02. This is particularly advantageous for uniform force reception or force introduction. Furthermore, as already recognizable in the illustration of FIG. 1, the locking elements 03 are disposed in such a manner that these, for example defined via the rear locking surfaces 07, span a plane that extends perpendicular to the first direction 08 in which the brewing-chamber half 02 is moved, in particular displaced, in the carrier (not shown).

FIG. 2 shows a perspective view of the brewing-chamber half 02, but now in a representation in which the brewing-chamber half 02 is received in a corresponding carrier 09. FIG. 2 shows a section through an edge area of the carrier 09, so that both the latching recesses 10 and the locking elements 03 engaging therein and the control valves controlling the locking elements 03 are shown in the sectional area in the form of control plates 11. The latching recesses 10 are disposed at the edges in horizontally extending surfaces or walls, in particular upper and lower casing walls 09.1, 09.2.

The control plate 11 has a groove 12 along the first direction 08, which engages with a guide web 13 on the surface of the interior casing 05 of the brewing-chamber half 02. The control plate is formed in one part, not two, as might be assumed. The interruption at the height of the groove is due to the choice of cut surface. In fact, the groove in width direction B only extends over part of the thickness of the otherwise one-piece control plate 11.

In contrast to FIG. 1, the sectional view of FIG. 2 no longer shows the reception 06 laterally attached to or laterally protruding from the control plate 11 for attaching or receiving a drive bolt. Overall, however, it can be seen that the control plate 11 is disposed so as to be movable along the guide web 13. This means that the control plate 11 is designed so as to be movable both with respect to the first brewing-chamber half 02 and thus also with respect to the locking elements 03 and with respect to the carrier 09. Reception 06 (not shown) is guided through recesses 14, preferably in the form of a slotted hole, through carrier 09, in particular laterally through carrier 09 to the outside. In other words, this means that the drive bolts are connected or linked to the control plate 11 from the outside towards the inside through the recess 14 in the carrier 09 and thus the control plates 11 are connected to a drive apparatus via external drive bolts, in particular drive bolts external in width direction B.

FIG. 2 illustrates the locking mechanism of the brewing unit 01. As long as the movable brewing-chamber half 02 has not reached the position shown in FIG. 2, in which the brewing-chamber halves 02, 32 are disposed in the locked position and the locking elements 03 have assumed the locked position, the control plate 11 is located along the guide web 13 in the rear area. In this state, in particular as long as the locking elements 03 do not yet engage in the latching recesses 10, the locking elements 03 are pivoted inwards around the kingpin 04 and are also prevented or secured against rotation by the upper casing wall 09.1 and/or the opposite lower casing wall 09.2, so that the long side 03.1 of the locking element 03 forms a stop for the control plate 11 and when the control plates 11 are driven, preferably via a drive pin contacted laterally from the outside, a force is applied to the control plate 11 against the inwardly rotated locking elements 03, in particular the long side 03.1 of the locking elements 03, and the control plate 11 leads to a displacement of the brewing-chamber half 02 along the first direction 08, the locking elements 03 serving as a stop for the control valves on both sides, in particular control plates 11.

Shortly before or when reaching the position or arrangement of the brewing-chamber half 02 as shown in FIG. 2, the rear ends 10.1 of the latching recesses 10 release the rotation of the locking elements 03 around the kingpin 04, so that the control plate 11 can then slide along the long sides 03.1 of the locking elements 03, while at the same time completing the movement of the brewing-chamber half 02 to reach the locked position and at the same time ensuring the locking or secures the locked position of the locking elements 03. For in the state shown in FIG. 2, the locking elements 03 are wedged or prevented in such a manner that the brewing-chamber half 02 is held in the position shown and at the same time the locking elements 03 are secured in their position, in particular in the locked position.

FIG. 3 shows a perspective view that essentially corresponds to the view in FIG. 2, but with the section through the brewing unit 01 removed. This reveals the drive bolt 15, which engages in the recess 06, which in turn connects the control plate 11 to the drive bolt 15. The drive bolt 15 is connected to a drive apparatus 28 outside the carrier 09. The drive apparatus comprises the drive-shaft extractor 16 disposed on the outside of the carrier 09, to which the drive bolt 15 is indirectly connected via a joint 18. In addition to the extractor legs 19, the drive-shaft extractor 16 has a rotation axis 20, which connects the extractor legs 19, is rotatably disposed on the carrier 09 and is pre-stressed with pre-stressing means 21 in a rotation direction R, which extends clockwise in the illustration of FIG. 3. The pre-stressing means 21 enable automatically opening the brewing-chamber halves 02, 32 and/or automatically unlocking the locking elements 03. The legs 22 joined to the extractor legs 19 via the joint 18 enable the circular movement of the joint 18 around the rotation axis 20 to be converted to a linear movement of the drive pin 15, in particular along the recess 14 in the carrier 09.

In FIG. 4, which shows another sectional view of a side view of a part of the brewing unit 01, the manner in which the control plate 11, the locking elements 03 and the latching recesses 10 interacting in the locked position of the brewing-chamber halves 02, 32 is shown again. At the same time, the rotation axis 20 connecting the extractor legs 19 can also be seen, the rotation axis 20 being pre-stressed with the pre-stressing means 21 in this illustration for a rotation R in the counterclockwise direction. It can also be seen that the control plates 11 have a guiding spike 29, which extends in the first direction 08 and is inserted in a spring-loaded reception 30 of the brewing-chamber half 02 when the locking elements 03 are moved to the locked position shown.

The section of FIG. 5 is a top view of a part of the brewing unit 01 in the closed and/or locked position. The section extends at the height of the recesses 14 of the carrier 09 and/or at the height of the drive bolts 15. Accordingly, the connection between the drive bolts 15 and the reception 16, which merges into the control plate 11, as well as the guiding spike 29, which extends or protrudes in the first direction or, and its reception 30 in the second brewing-chamber half 02 can be seen again in this view.

Furthermore, it can also be seen that the drive bolts 15 is connected to the extractor leg 19 via the arm 28 at the joint 18, the extractor leg 19 in turn being connected to the opposite extractor leg 19 via the rotation axis 20. It can also be seen that the control plate 11 has a flat outer base surface 24, which extends essentially parallel to a lateral wall 25 of the carrier 09. It can also be seen that the control plate 11 comes into contact with an opposite, inner, concave base surface 26 on a convex surface 27 of an interior casing 05 of the brewing-chamber half 02. Also recognizable is the guide web 13, which extends along the first direction 08 on the interior casing 05 of the brewing-chamber half 02.

### LIST OF REFERENCE NUMERALS

01 brewing unit
02 brewing-chamber half03 locking elements
03.1 long side
04 kingpin
05 interior casing
06 reception
07 locking surfaces
08 first direction
09 carrier
09.1 upper casing wall
09.2 lower casing wall
10 latching recesses
10.1 rearward ends
11 control plate
12 groove
13 guide web
14 recesses
15 drive bolts
16 drive-shaft extractor
18 joint
19 extractor legs
20 rotation axis
21 pre-stressing means
22 pre-stressing means
24 base surface
25 lateral wall
26 concave base surface
27 convex surface
28 drive apparatus
29 guiding spike
30 reception
32 brewing-chamber half
B width direction
H height direction
R rotation direction

1. A brewing unit (01) for a beverage preparation device for substrate portions, the brewing unit (01) comprising a carrier (09) and a brewing chamber, which has at least two brewing-chamber halves (02, 32) movable in relation to each other in a first direction (08), and a drive apparatus (28), by means of which at least one brewing-chamber half (02) is movable in relation to the carrier (09) so the brewing-chamber halves (02, 32) are transferable to at least an open position and a locked position, and a separate locking mechanism for locking the brewing-chamber halves (02, 32) in a locked position, the locking mechanism comprising four locking elements (03), wherein the locking elements (03) are movable in pairs between a locked position and a released position via movable control valves each disposed between two locking elements (03), the control valves being designed as plano-concave control plates (11), the control valves having an exterior, plane base surface (24), which is disposed parallel to lateral walls (25) of the carrier (09), and having an opposite, interior, concave base surface (26), which is disposed so as to be movable with respect to a convex surface (27) of an interior casing (05) of a brewing-chamber half (02).

2. The brewing unit according to claim 1,
wherein
the locking elements (03) span a plane perpendicular to the first direction (08).

3. The brewing chamber according to claim 1,
characterized in that wherein
the carrier (09) has latching recesses (10) or latching indentations, which are formed in horizontal surfaces.

4. The brewing unit according to claim 3,
wherein
the latching recesses (10) are disposed in the edge area of the carrier (09) abutting to a lateral wall (25) of the carrier (09) in a width direction (B) perpendicular to the first direction (08).

5. The brewing unit according to claim 3,
wherein
the locking elements (03) engage in the latching recesses (10) in pairs from the inside towards the top and towards the bottom for attaining the locked position.

6. The brewing unit according to claim 1,
wherein
the locking elements (03) are connected to the movable brewing-chamber halves (02) such that a movement of the brewing-chamber halves (02) causes a corresponding translational movement of the locking elements (03) in the first direction (08).

7. The brewing unit according to claim 1,
wherein
the locking elements (03) are each connected to a brewing-chamber half (02), which is formed so as to be movable with respect to the carrier (09), in a pivotable manner via kingpins (04), which extend in the width direction (B) and are provided on both sides.

8. The brewing unit according to claim 1,
wherein
the control valves are formed so as to be movable in the first direction (08) with respect to the brewing-chamber halves (02) mounted movable with respect to the carrier (09).

9. The brewing unit according to claim 1,
wherein
the control valves are designed as control plates (11), whose surface (24) extends parallel to lateral walls (25) of the carrier (09).

10. The brewing unit according to claim 1,
wherein
the concave base surface (26) of the control plate (11) has a groove (12) along the first direction (08), the groove (12) being engaged with a guide web (13) on a convex surface (27) of an interior casing (05) of the movable brewing-chamber half (02).

11. The brewing unit according to claim 1,
wherein
the control plate (11) has a guiding spike (22), which extends in the first direction (08) and is inserted in a spring-loaded reception (30) of the brewing-chamber half (02) when transferring the locking elements (03) to the locked position.

12. The brewing unit according to claim 1,
wherein
the control valves are connected to the drive apparatus (28) via external drive bolts (15) external in the width direction (B).

13. The brewing unit according to claim 12,
wherein
the drive bolts (15) extend through recesses (14) in the carrier (09) on both sides of the brewing unit (01).

14. The brewing unit according to claim 12,
wherein
the drive bolts (15) are connected to a drive-shaft extractor (16) of the drive apparatus (28), the drive-shaft extractor (16) being disposed on the exterior of the carrier (09).

15. The brewing unit according to claim 14,
wherein
the drive-shaft extractor (16) comprises a rotation axis (20) which connects the extractor legs (19), is disposed on the carrier (09) so as to be rotational and is pre-stressed in a rotation direction (R) using pre-stressing means (21).

16. (canceled)

17. (canceled)

18. The brewing unit according to claim 1, wherein the beverage preparation device comprises a coffee machine for pre-portioned coffee units.

19. The brewing unit according to claim 1, wherein the locking elements (03) are pivotable in pairs between the locked position and the released position.

20. The brewing unit according to claim 12, wherein the control valves comprise control plates (11).

21. The brewing unit according to claim 14, wherein the drive bolts (15) are connected to extractor legs (19) movable along lateral walls (25) of the carrier (09) on both sides.
